(19) United States
(12) Patent Application Publication
(10) Pub. No.: US 2002/0061976 A1
(43) Pub. Date: May 23, 2002

(54) Propylene polymer composition

(76) Inventors: Franciscus J.T. Krabbenborg, Terneuzen (NL); Dagmar JJM van Heur, Eppstein-Vockenhausen (DE); Neldes J. Hovestad, Sint Jansteen (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/935,860

(22) Filed: Aug. 23, 2001

Related U.S. Application Data
(60) Provisional application No. 60/267,534, filed on Feb. 9, 2001.
(60) Provisional application No. 60/233,002, filed on Sep. 15, 2000.

(51) Int. Cl. C08L 23/00

(52) U.S. Cl. 525/240

(57) ABSTRACT

Disclosed are fabricate automotive articles comprising a propylene polymer composition comprising a polypropylene, an interpolymer prepared from a metallocene catalyst, and optionally a filler. Said fabricated automotive articles have a good balance of stiffness and toughness and demonstrate improved scratch and mar resistance.

### CROSS REFERENCE STATEMENT

This application claims the benefit of U.S. Provisional Application No. 60/267,534, filed Feb. 9, 2001 and U.S. Provisional Application No. 60/233,002, filed Sep. 15, 2000.

### FIELD OF THE INVENTION

This invention relates to a propylene polymer composition and articles fabricated therefrom.

### BACKGROUND OF THE INVENTION

Polypropylene, especially highly isotactic polypropylene, has been used in many applications in the form of molded articles, film, sheet, etc., because it is excellent in molding processability, toughness, moisture resistance, gasoline resistance, chemical resistance, has a low specific gravity, and is inexpensive. The use of polypropylene polymers is expanding at an increasing rate in the fields of exterior and interior automotive trims, in electrical and electrical equipment device housing and covers as well as other household and personal articles.

However, many automotive applications require fabricated articles with greater heat resistance, impact resistance, stiffness, compressive set and/or scratch and mar resistance than conventional polypropylenes can provide. Further, in certain automotive applications it is desirable to provide reduced coefficient of linear thermal expansion (CLTE). Extremes in temperature conditions can result in misfitting of various components of the finished product. A bumper fascia or instrument panel which expand excessively will in extreme heat conditions result in buckling or misfit in the assembled finished product.

In order to improve performance, especially impact resistance, polypropylene has been blended with a rubbery elastic material such as ethylene-propylene copolymer rubber, ethylene-propylene-diene copolymer rubber or ethylene-butene copolymer rubber. For examples, see U.S. Pat. No. 5,391,618 which discloses low crystalline polypropylene polymer compositions comprising an ethylene alpha-olefin copolymer, U.S. Pat. No. 5,576,374 which discloses propylene polymer compositions comprising a substantially linear ethylene polymer and U.S. Pat. No. 5,639,829 which discloses propylene polymer compositions comprising an ethylene and 1-butene random copolymer. However, while impact properties are improved these propylene polymer compositions do not achieve a good balance of stiffness, toughness, and scratch and mar resistance.

It would be highly desirable to provide fabricated articles comprising a propylene polymer composition which exhibits a good balance of stiffness, toughness, compressive set, reduced CLTE and scratch and mar resistance.

### SUMMARY OF THE INVENTION

The present invention is such a desirable fabricated automotive article comprising an isotatic propylene polymer; at least one substantially random interpolymer prepared by polymerizing ethylene and/or one or more α-olefin monomers with one or more vinyl or vinylidene aromatic monomers and/or one or more hindered aliphatic or cycloaliphatic vinylidene monomers, and optionally with other polymerizable ethylenically unsaturated monomer(s); and optionally a filler.

In a further aspect, the present invention involves a method of molding or extruding a fabricated automotive article from a propylene polymer composition described hereinabove.

Examples of the fabricated automotive articles of the present invention include bumper fascia, spoilers, pillars, door trim, instrument panels, airbag covers, consoles, mats, interior skins, weather stripping, window seals, shift lever knob and soft tough over-moldings, for example arm rests.

### DETAILED DESCRIPTION OF THE EMBODIMENTS

Component (a) in the propylene polymer compositions of this invention is one or more isotatic propylene polymer. Propylene polymers suitable for use in this invention are well known in the literature and can be prepared by known techniques. Propylene polymers used for the present invention are preferably one or more homopolymer of polypropylene; one or more copolymer, for example, random or block copolymers, of propylene and an alpha-olefin, preferably a C₂, or C₄ to C₂₀ alpha-olefin; or combinations thereof. The alpha-olefin is present in the polypropylene of the present invention in an amount of not more than 20 percent by mole, preferably not more than 15 percent, even more preferably not more than 10 percent and most preferably not more than 5 percent by mole.

Examples of the C₂, and C₄ to C₂₀ alpha-olefins for constituting the propylene and alpha-olefin copolymer include ethylene, 1-butene, 1-pentene, 1-hexene, 1-heptene, 1-octene, 1-decene, 1-dodecene, 1-hexadodecene, 4-methyl-1-pentene, 2-methyl-1-butene, 3-methyl-1-butene, 3,3-dimethyl-1-butene, diethyl-1-butene, trimethyl-1-butene, 3-methyl-1-pentene, ethyl-1-pentene, propyl-1-pentene, dimethyl-1-pentene, methylethyl-1-pentene, diethyl-1-hexene, trimethyl-1-pentene, 3-methyl-1-hexene, dimethyl-1-hexene, 3,5,5-trimethyl-1-hexene, methylethyl-1-heptene, trimethyl-1-heptene, dimethyloctene, ethyl-1-octene, methyl-1-nonene, vinylcyclopentene, vinylcyclohexene and vinylnorbomene, where alkyl branching position is not specified it is generally on position 3 or higher of the alkene.

The propylene polymer of the present invention can be prepared by various processes, for example, in a single stage or multiple stages, by such polymerization method as slurry polymerization, gas phase polymerization, bulk polymerization, solution polymerization or a combination thereof using a metallocene catalyst or a so-called Ziegler-Natta catalyst, which usually is one comprising a solid transition metal component comprising titanium. Particularly a catalyst consisting of, as a transition metal/solid component, a solid composition of titanium trichoride which contains as essential components titanium, magnesium and a halogen; as an organometalic component an organoaluminum compound; and if desired an electron donor. Preferred electron donors are organic compounds containing a nitrogen atom, a phosphorous atom, a sulfur atom, a silicon atom or a boron atom, and preferred are silicon compounds, ester compounds or ether compounds containing these atoms.

Propylene polymers are commonly made by catalytically reacting propylene in a polymerization reactor with appropriate molecular weight control agents. Nucleating agents may be added after the reaction is completed during a melt processing step in order to promote crystal formation. The polymerization catalyst should have high activity and be capable of generating highly tactic polymer. The reactor system must be capable of removing the heat of polymerization from the reaction mass, so the temperature and pressure of the reaction can be controlled appropriately.

A good discussion of various polypropylene polymers is contained in Modem Plastics Encyclopedia/89, mid October 1988 Issue, Volume 65, Number 11, pp. 86-92, the entire disclosure of which is incorporated herein by reference. The molecular weight of the propylene polymer for use in the present invention is conveniently indicated using a melt flow measurement, sometimes referred to as melt flow rate (MFR) or melt index (MI), according to ASTM D 1238 at 230° C. and an applied load of 2.16 kilogram (kg). Melt flow rate is inversely proportional to the molecular weight of the polymer. Thus, the higher the molecular weight, the lower the melt flow rate, although the relationship is not linear. The melt flow rate for the polypropylene useful herein is generally greater than 0.1 g/10 min., preferably greater than about 0.5 g/10 min., more preferably greater than about 1 g/10 min., and even more preferably greater than about 10 g/10 min. The melt flow rate for the polypropylene useful herein is generally less than about 200 g/10 min., preferably less than about 100 g/10 min., more preferably less than about 75 g/10 min., and more preferably less than about 50 g/10 min.

The propylene polymer as component (a) may be characterized by its crystalline structure. A preferable method of determining crystallinity in the propylene polymers is by differential scanning calorimetry (DSC). A small sample (milligram size) of the propylene polymer is sealed into an aluminum DSC pan. The sample is placed into a DSC cell with a 25 centimeter per minute nitrogen purge and cooled to about −100° C. A standard thermal history is established for the sample by heating at 10° C. per minute to 225° C. The sample is then cooled to about −100° C. and reheated at 10° C. per minute to 225° C. The observed heat of fusion (ΔH_{observed}) for the second scan is recorded. The observed heat of fusion is related to the degree of crystallinity in weight percent based on the weight of the propylene polymer sample by the following equation:

$$Crystallinity , \% = \frac{Δ {H}_{observed}}{Δ {H}_{isotactic PP} \times 100}$$

where the heat of fusion for isotactic polypropylene (ΔH_{isotactic PP}), as reported in B. Wunderlich, Macromolecular Physics, Volume 3, Crystal Melting, Academic Press, New Your, 1980, p 48, is 165 Joules per gram (J/g) of polymer.

In the present invention, a more preferred propylene polymer is an isotatic propylene homopolymer or copolymer having a high degree of crystallinity. As defined herein, a high degree of crystallinity, as determined by DSC, is at least about 62 weight percent, preferably at least about 64 weight percent, more preferably at least about 66 weight percent, even more preferably at least about 68 weight percent and most preferably at least about 70 weight percent based on the weight of the propylene polymer. The degree of crystallinity for the propylene polymer, as determined by DSC, is less than or equal to about 100 weight percent, preferably less than or equal to about 90 weight percent, more preferably less than or equal to about 80 weight percent, and most preferably less than or equal to about 70 weight percent based on the weight of the propylene polymer.

Part or all of the propylene polymer of the present invention may be graft modified. A preferred graft modification of the polypropylene is achieved with any unsaturated organic compound containing, in addition to at least one ethylenic unsaturation (for example, at least one double bond), at least one carbonyl group (—C═O) and that will graft to a polypropylene as described above. Representative of unsaturated organic compounds that contain at least one carbonyl group are the carboxylic acids, anhydrides, esters and their salts, both metallic and nonmetallic. Preferably, the organic compound contains ethylenic unsaturation conjugated with a carbonyl group. Representative compounds include maleic, fumaric, acrylic, methacrylic, itaconic, crotonic, -methyl crotonic, and cinnamic acid and their anhydride, ester and salt derivatives, if any. Maleic anhydride is the preferred unsaturated organic compound containing at least one ethylenic unsaturation and at least one carbonyl group.

The unsaturated organic compound containing at least one carbonyl group can be grafted to the polypropylene by any known technique, such as those taught in U.S. Pat. No. 3,236,917 and U.S. Pat. No. 5,194,509. For example, polymer is introduced into a two-roll mixer and mixed at a temperature of 60° C. The unsaturated organic compound is then added along with a free radical initiator, such as, for example, benzoyl peroxide, and the components are mixed at 30° C. until the grafting is completed. Alternatively, the reaction temperature is higher, for example, 210° C. to 300° C., and a free radical initiator is not used or is used at a reduced concentration. An alternative and preferred method of grafting is taught in U.S. Pat. No. 4,905,541, the disclosure of which is incorporated herein by reference, by using a twin-screw devolatilizing extruder as the mixing apparatus. The polypropylene and unsaturated organic compound are mixed and reacted within the extruder at temperatures at which the reactors are molten and in the presence of a free radical initiator. Preferably, the unsaturated organic compound is injected into a zone maintained under pressure in the extruder.

The unsaturated organic compound content of the grafted polypropylene is at least about 0.01 weight percent, preferably at least about 0.1 weight percent, more preferably at least about 0.5 weight percent, and most preferably at least about 1 weight percent based on the combined weight of the polypropylene and organic compound. The maximum amount of unsaturated organic compound content can vary to convenience, but typically it does not exceed about 10 weight percent, preferably it does not exceed about 5 weight percent, more preferably it does not exceed about 2 weight percent and most preferably it does not exceed about 1 weight percent based on the combined weight of the polypropylene and the organic compound.

The propylene polymer or graft-modified propylene polymer is employed in the propylene polymer compositions of the present invention in amounts sufficient to provide the desired processability and good balance of stiffness and toughness. If present, the graft-modified polypropylene can be employed in an amount equal to 100 weight percent of the total weight of the polypropylene, preferably in an amount up to or equal to 50 weight percent, more preferably up to or equal to 30 weight percent, even more preferably up to or equal to 20 weight percent and most preferably up to or equal to 10 weight percent of the weight of the polypropylene.

In general, the propylene polymer, graft-modified propylene polymer or mixture thereof is employed in an amount from about 20 to about 95 parts, more preferably from about 20 to about 80 parts and most preferably from about 20 to about 70 parts by weight based on the total weight of the propylene polymer composition. If the flexural modulus of the of propylene polymer composition of the present invention is desired to be greater than about 450 megapascals (MPa), preferably the polypropylene, graft-modified polypropylene or mixture thereof is generally employed in an amount from about 40 to about 80 parts by weight, preferably about 40 to about 70 parts by weight and most preferably about 40 to about 60 parts by weight based on the total weight of the propylene polymer composition. However, if the flexural modulus of the of propylene polymer composition of the present invention is less than about 450 MPa the polypropylene, graft-modified polypropylene or mixture thereof is generally employed in an amount from about 5 to about 40 parts by weight, preferably about 20 to about 40 parts by weight and most preferably from about 20 to about to about 30 parts by weight based on the total weight of the propylene polymer composition.

Suitable interpolymers employed in the present invention as component (b) include, but are not limited to substantially random interpolymers. The term interpolymer as used herein means a polymer wherein two or more different monomers are polymerized to form the interpolymer. The term interpolymer is interchangeable with the term copolymer.

Preferably, the substantially random interpolymers are prepared by polymerizing i) ethylene and/or one or more α-olefin monomers and ii) one or more vinyl or vinylidene aromatic monomers and/or one or more sterically hindered aliphatic or cycloaliphatic vinyl or vinylidene monomers, and optionally iii) other polymerizable ethylenically unsaturated monomer(s). Suitable α-olefins include for example, α-olefins containing from 3 to about 20, preferably from 3 to about 12, more preferably from 3 to about 8 carbon atoms. Particularly suitable are ethylene, propylene, butene-1,4-methyl-1-pentene, hexene-1 or octene-1 or ethylene in combination with one or more of propylene, butene-1,4-methyl-1-pentene, hexene-1 or octene-1. These α-olefins do not contain an aromatic moiety.

Suitable vinyl or vinylidene aromatic monomers which can be employed to prepare the interpolymers include, for example, those represented by the following formula:

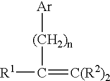

wherein R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; Ar is a phenyl group or a phenyl group substituted with from 1 to 5 substituents selected from the group consisting of halo, C₁₋₄-alkyl, and C₁₋₄-haloalkyl; and n has a value from zero to about 4, preferably from zero to 2, most preferably zero. Exemplary vinyl aromatic monomers include styrene, vinyl toluene, α-methylstyrene, t-butyl styrene, chlorostyrene, including all isomers of these compounds, and the like. Particularly suitable such monomers include styrene and lower alkyl- or halogen-substituted derivatives thereof. Preferred monomers include styrene, α-methyl styrene, the lower alkyl-(C₁-C₄) or phenyl-ring substituted derivatives of styrene, such as for example, ortho-, meta-, and para-methylstyrene, the ring halogenated styrenes, para-vinyl toluene or mixtures thereof, and the like. A more preferred aromatic vinyl monomer is styrene.

By the term “sterically hindered aliphatic or cycloaliphatic vinyl or vinylidene compounds”, it is meant addition polymerizable vinyl or vinylidene monomers corresponding to the formula:

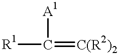

wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system. Preferred aliphatic or cycloaliphatic vinyl or vinylidene compounds are monomers in which one of the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl, norbomyl, and the like. Most preferred aliphatic or cycloaliphatic vinyl or vinylidene compounds are the various isomeric vinyl-ring substituted derivatives of cyclohexene and substituted cyclohexenes, and 5-ethylidene-2-norbomene. Especially suitable are 1-, 3-, and 4-vinylcyclohexene and 5-ethylidene-2-norbomene. Simple linear non-branched α-olefins including for example, α-olefins containing from 3 to about 20 carbon atoms such as propylene, butene-1,4-methyl-1-pentene, hexene-1 or octene-1 are not examples of sterically hindered aliphatic or cycloaliphatic vinyl or vinylidene compounds.

Other optional polymerizable ethylenically unsaturated monomer(s) include norbomene and C₁₋₁₀ alkyl or C₆₋₁₀ aryl substituted norbomenes, with an exemplary interpolymer being ethylene/styrene/norbomene.

Preferred substantially random interpolymers are the ethylene/propylene/styrene, ethylene/styrene/norbomene, and ethylene/propylene/styrene/norbomene interpolymers. The most preferred substantially random interpolymers are ethylene/styrene interpolymers.

The substantially random interpolymers include the pseudo-random interpolymers as described in EP-A-0,416,815 by James C. Stevens et al. and U.S. Pat. No. 5,703,187 by Francis J. Timmers, both of which are incorporated herein by reference in their entirety. The substantially random interpolymers can be prepared by polymerizing a mixture of polymerizable monomers in the presence of one or more metallocene or constrained geometry catalysts in combination with various cocatalysts. Preferred operating conditions for such polymerization reactions are pressures from atmospheric up to 3000 atmospheres and temperatures from −30° C. to 200° C. Polymerizations and unreacted monomer removal at temperatures above the autopolymerization temperature of the respective monomers may result in formation of some amounts of homopolymer polymerization products resulting from free radical polymerization.

The term “substantially random” (in the substantially random interpolymer comprising polymer units derived from ethylene and one or more α-olefin monomers with one or more vinyl or vinylidene aromatic monomers and/or sterically hindered aliphatic or cycloaliphatic vinyl or vinylidene monomers) as used herein means that the distribution of the monomers of said interpolymer can be described by the Bernoulli statistical model or by a first or second order Markovian statistical model, as described by J. C. Randall in POLYMER SEQUENCE DETERMINATION, Carbon-13 NMR Method, Academic Press New York, 1977, pp. 71-78. Preferably, substantially random interpolymers do not contain more than 15 percent of the total amount of vinyl aromatic monomer in blocks of vinyl aromatic monomer of more than 3 units. More preferably, the interpolymer is not characterized by a high degree of either isotacticity or syndiotacticity. This means that in the carbon⁻¹³ NMR spectrum of the substantially random interpolymer the peak areas corresponding to the main chain methylene and methine carbons representing either meso diad sequences or racemic diad sequences should not exceed 75 percent of the total peak area of the main chain methylene and methine carbons.

Examples of suitable catalysts and methods for preparing the substantially random interpolymers are disclosed in U.S. Pat. No. 6,118,013 (EP-A-514,828); as well as U.S. Pat. Nos. 5,055,438; 5,057,475; 5,096,867; 5,064,802; 5,132,380; 5,189,192; 5,321,106; 5,347,024; 5,350,723; 5,374,696; 5,399,635; 5,470,993; 5,703,187; and 5,721,185 all of which patents and applications are incorporated herein by reference.

The substantially random α-olefin/vinyl aromatic interpolymers can also be prepared by the methods described in JP 07/278230 employing compounds shown by the general formula

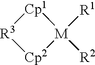

where Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf, most preferably Zr; and R³ is an alkylene group or silanediyl group used to cross-link Cp¹ and Cp².

The substantially random α-olefin/vinyl aromatic interpolymers can also be prepared by the methods described by John G. Bradfute et al. (W. R. Grace & Co.) in WO 95/32095; by R. B. Pannell (Exxon Chemical Patents, Inc.) in WO 94/00500; and in Plastics Technology, p. 25 (September 1992), all of which are incorporated herein by reference in their entirety.

Also suitable are the substantially random interpolymers which comprise at least one α-olefin/vinyl aromatic/vinyl aromatic/α-olefin tetrad disclosed U.S. Pat. No. 6,191,245 and WO 98/09999 both by Francis J. Timmers et al., the entire contents of both of which are herein incorporated by reference. These interpolymers contain additional signals in their carbon-13 NMR spectra with intensities greater than three times the peak to peak noise. These signals appear in the chemical shift range 43.70-44.25 ppm and 38.0-38.5 ppm. Specifically, major peaks are observed at 44.1, 43.9, and 38.2 ppm. A proton test NMR experiment indicates that the signals in the chemical shift region 43.70-44.25 ppm are methine carbons and the signals in the region 38.0-38.5 ppm are methylene carbons.

Further preparative methods for the interpolymers used in the present invention have been described in the literature. Longo and Grassi (Makromol. Chem., Volume 191, pages 2387 to 2396 [1990]) and D'Anniello et al. (Journal of Applied Polymer Science, Volume 58, pages 1701-1706 [1995]) reported the use of a catalytic system based on methylalumoxane (MAO) and cyclopentadienyltitanium trichloride (CpTiCl₃) to prepare an ethylene-styrene copolymer. Xu and Lin (Polymer Preprints, Am. Chem. Soc., Div. Polym. Chem.) Volume 35, pages 686,687 [1994]) have reported copolymerization using a MgCl₂/TiCl₄/NdCl₃/Al(iBu)₃ catalyst to give random copolymers of styrene and propylene. Lu et al (Journal of Applied Polymer Science, Volume 53, pages 1453 to 1460 [1994]) have described the copolymerization of ethylene and styrene using a TiCl₄/NdCl₃/MgCl₂/Al(Et)₃ catalyst. Sernetz and Mulhaupt, (Macromol. Chem. Phys., v. 197, pp. 1071-1083, 1997) have described the influence of polymerization conditions on the copolymerization of styrene with ethylene using Me₂Si(Me₄Cp)(N-tert-butyl)TiCl₂/methylaluminoxane Ziegler-Natta catalysts. Copolymers of ethylene and styrene produced by bridged metallocene catalysts have been described by Arai, Toshiaki and Suzuki (Polymer Preprints, Am. Chem. Soc., Div. Polym. Chem.) Volume 38, pages 349, 350 [1997]) and in U.S. Pat. No. 5,652,315, issued to Mitsui Toatsu Chemicals, Inc. The manufacture of α-olefin/vinyl aromatic monomer interpolymers such as propylene/styrene and butene/styrene are described in U.S. Pat. No. 5,244,996, issued to Mitsui Petrochemical Industries Ltd or U.S. Pat. No. 5,652,315 also issued to Mitsui Petrochemical Industries Ltd or as disclosed in DE 197 11 339 A1 and U.S. Pat. No. 5,883,213 to Denki Kagaku Kogyo KK. All the above methods disclosed for preparing the interpolymer component are incorporated herein by reference. Also, although of high isotacticity and therefore not “substantially random”, the random copolymers of ethylene and styrene as disclosed in Polymer Preprints Vol 39, No. 1, March 1998 by Toru Aria et al. can also be employed as blend components for the foams of the present invention.

While preparing the substantially random interpolymer, an amount of atactic vinyl aromatic homopolymer may be formed due to homopolymerization of the vinyl aromatic monomer at elevated temperatures. The presence of vinyl aromatic homopolymer is in general not detrimental for the purposes of the present invention and can be tolerated. The vinyl aromatic homopolymer may be separated from the interpolymer, if desired, by extraction techniques such as selective precipitation from solution with a non solvent for either the interpolymer or the vinyl aromatic homopolymer. For the purpose of the present invention it is preferred that no more than 30 weight percent, preferably less than 20 weight percent based on the total weight of the interpolymers of atactic vinyl aromatic homopolymer is present.

The substantially random interpolymer is employed in the blends of the present invention in amounts sufficient to provide the desired balance of processability and impact resistance. In general, the substantially random interpolymer is employed in an amount from about 80 to 5 parts by weight based on the weight of the total propylene polymer 0 composition. If the flexural modulus of the of propylene polymer composition of the present invention is greater than about 450 MPa, preferably the substantially random interpolymer is generally employed in an amount from about 60 to 5 parts by weigh based on the total weight of the propylene polymer composition. However, if the flexural modulus of the of propylene polymer composition of the present invention is less than about 450 MPa the substantially random interpolymer is generally employed in an amount from about 80 to 65 parts by weigh based on the total weight of the propylene polymer composition.

Optionally, the propylene polymer composition comprises component (c) a filler such as calcium carbonate, talc, clay, mica, wollastonite, hollow glass beads, titaninum oxide, silica, carbon black, glass fiber or potassium titanate. Preferred fillers are talc, wollastonite, clay, single layers of a cation exchanging layered silicate material or mixtures thereof. Talcs, wollastonites, and clays are generally known fillers for various polymeric resins. See for example U.S. Pat. Nos. 5,091,461 and 3,424,703; EP 639,613 A1; and EP 391,413, where these materials and their suitability as filler for polymeric resins are generally described.

Preferred talcs and clays are uncalcined having very low free metal oxide content. The mineral talcs best suited are hydrated magnesium silicates as generally represented by the theoretical formula

3MgO.4SiO₂.H₂O

Compositions of talcs may vary somewhat with locality in which they are mined. Montana talcs, for example, closely approach this theoretical composition. Suitable mineral talcs of this type are commercially available as MISTRON™ G7C available from Luzenac.

Examples of preferred cation exchanging layered silicate materials include biophilite, kaolinite, dickalite or talc clays; smectite clays; vermiculite clays; mica; brittle mica; Magadiite; Kenyaite; Octosilicate; Kanemite; and Makatite. Preferred cation exchanging layered silicate materials are smectite clays, including montmorillonite, bidelite, saponite and hectorite.

Preferred fillers have an average length to thickness ratio (L/T) preferably from about 1 to about 10,000 and provide the desired levels of physical and other property requirements such as toughness and stiffness (modulus). Several varieties of cation exchanging layered silicate materials, talc, wollastonite, clay and mixtures thereof have been found to be especially suitable.

The suitability of cation exchanging layered silicate material fillers in maintaining the preferred levels of toughness and stiffness of molded articles prepared from the resin has been found to be a function of the average L/T of the filler particles together with obtaining a uniformly small particle-sized filler. Highly preferred are those compositions incorporating fillers having an average L/T as measured according to the below-described technique of at least about 1, preferably at least about 15, more preferably at least about 50, even more preferably at least about 100, and most preferably at least about 200. With regard to the maximum level for the L/T ratio, it has been found desirable to have a value up to and including about 10,000, preferably up to and including about 5,000, more preferably up to and including about 1,000, even more preferably up to and including about 500, and most preferably up to and including about 200.

The suitability of non-cation exchanging layered silicate material fillers, such as calcium carbonate, talc, clay, mica, wollastonite, hollow glass beads, titaninum oxide, silica, carbon black, glass fiber, potassium, titanate, etc., in maintaining the preferred levels of toughness and stiffness of molded articles prepared from the resin has been found to be a function of the average L/T of the filler particles together with obtaining a uniformly small particle-sized filler. Highly preferred are those compositions incorporating non-cation exchanging layered silicate material fillers having an average L/T as measured according to the below-described technique of at least about 1, preferably at least about 1.5, more preferably at least about 2, even more preferably at least about 3, and most preferably at least about 4. With regard to the maximum level for the L/T ratio for non-cation exchanging layered silicate material fillers, it has been found desirable to have a value up to and including about 30, preferably up to and including about 20, more preferably up to and including about 15, even more preferably up to and including about 10, and most preferably up to and including about 4.

For determining the particle size and L/T ratio, the length of the fillers (or longest dimension, such as the diameter of a plate-shaped particle) as well as their thickness (shortest dimension of the 2 dimensions measurable) can be measured by preparing a filler modified polymeric resin sample and measuring the particle dimensions of the dispersed particles from digitized images produced by back scattered electron imaging using a scanning electron microscope and analyzing the digitized images in an image analyzer. Preferably, the size of the image is at least 10× the size of the maximum particle size.

The propylene polymer compositions included within the scope of this invention generally utilize such inorganic fillers with a number average particle size as measured by back scattered electron imaging using a scanning electron microscope of less than or equal to about 10 micrometers (μm) preferably less than or equal to about 3 μm, more preferably less than or equal to about 2 μm, more preferably less than or equal to about 1.5 μm and most preferably less than or equal to about 1.0 μm. In general, smaller average particle sizes equal to or greater than about 0.001 μm, preferably equal to or greater than about 0.01 μm, more preferably equal to or greater than about 0.1 μm, or most preferably equal to or greater than 0.5 μm, if available, could very suitably be employed.

If present, the filler is employed in an amount of at least about 1 part by weight, preferably at least about 3 parts by weight, more preferably at least about 5 parts by weight, even more preferably at least about 10 parts by weight, and most preferably at least about 15 parts by weight based on the total weight of the propylene polymer composition. Usually it has been found sufficient to employ an amount of filler up to and including about 50 parts by weight, preferably up to and including about 40 parts by weight, more preferably up to and including about 30 parts by weight, more preferably up to and including about 25 parts by weight, more preferably up to and including about 20 parts by weight, and most preferably up to and including about 15 parts by weight based the total weight of the propylene polymer composition.

Optionally, the propylene polymer composition comprises component (d) an additional polymer which is a polymer other than components (a) and (b) above. Preferred additional polymers are polyethylene, preferably low density polyethylene, linear low density polyethylene (LLDPE), high density polyethylene (HDPE), for example HDPE 96003E high density polyethylene available from The Dow Chemical Company; polystyrene; polycyclohexylethane; polyesters, such as polyethylene terephthalate; ethylene/styrene interpolymers; syndiotatic PP; syndiotactic PS; ethylene/propylene copolymers; EPDM; and mixtures thereof. If present, the additional polymer is employed in amounts of at least about 1 part by weight, preferably at least about 3 parts by weight, more preferably at least about 5 parts by weight, even more preferably at least about 7 parts by weight and most preferably at least about 10 parts by weight based on the weight of the total propylene polymer composition. In general, the additional polymer is used in amounts less than or equal to about 40 parts by weight, preferably less than or equal to about 30 parts by weight, more preferably less than or equal to about 20 parts by weight, even more preferably less than or equal to about 15 parts by weight and most preferably 12 parts by weight based on the weight of the total propylene polymer composition.

The compositions of the present invention can comprise (e) a slip agent. Preferably the slip agent is ionic more preferably the slip agent is non-ionic. Exemplary of ionic slip agents are salt derivatives of aromatic or aliphatic hydrocarbon oils, such as magnesium stearate, calcium stearate or zinc stearate.

Useful non-ionic slip agents include, but are not limited to, for example, aromatic or aliphatic hydrocarbon oils, as well as esters, amides, alcohols and acids of such oils, for example, mineral oils, naphthenic oils, paraffinic oils, glycerol monostearate, pentaerythritol monooleate, stearamides, saturated fatty acid amides or ethylenebis(amides), unsaturated fatty acid amides or ethylenebis(amides), adipic acid, sebacic acid, styrene-alpha-methyl styrene, natural oils such as castor, corn, cottonseed, olive, rapeseed, soybean, sunflower, other vegetable and animal oils, as well as esters, alcohols, and acids of the oils, polyether polyols or waxes, such as polyethylene waxes.

Preferred non-ionic slip agents are glycols or fluoro-containing polymers. Even more preferred non-ionic slip agents are silicone polymers, preferably silicone oils. Most preferred non-ionic slip agents are unsaturated fatty acid amides for example, oleamide, erucamide, linoleamide, and mixtures thereof.

Generally preferred concentrations of the slip agent is in the range of from about 0.1 parts to about 0.5 parts by weight, preferably of from about 0.1 parts to about 0.4 parts by weight and most preferably of from about 0.2 parts to about 0.3 parts by weight based on the weight of the total propylene polymer composition.

Further, the claimed propylene polymer compositions may also optionally contain one or more additives that are commonly used in propylene polymer compositions of this type. Preferred additives of this type include, but are not limited to: ignition resistant additives, stabilizers, colorants, antioxidants, antistats, flow enhancers, nucleating agents, including clarifying agents, etc. Preferred examples of additives are ignition resistance additives, such as, but not limited to halogenated hydrocarbons, halogenated carbonate oligomers, halogenated diglycidyl ethers, organophosphorous compounds, fluorinated olefins, antimony oxide and metal salts of aromatic sulfur, or a mixture thereof may be used. Further, compounds which stabilize polymer compositions against degradation caused by, but not limited to heat, light, and oxygen, or a mixture thereof may be used.

Depending on the additive and the desired effect, such additives may be present in an amount from at least about 0.01 parts, preferably at least about 0.1 parts, more preferably at least about 1 part, more preferably at least about 2 parts and most preferably at least about 5 parts by weight based on the total weight of the propylene polymer composition. Generally, the additive is present in an amount less than or equal to about 25 parts, preferably less than or equal to about 20 parts, more preferably less than or equal to about 15 parts, more preferably less than or equal to about 12 parts, and most preferably less than or equal to about 10 parts by weight based on the total weight of propylene polymer composition.

Further, the propylene polymer compositions of the present invention may also optionally contain one or more additives that are commonly used in propylene polymer compositions of this type. Preferred additives of this type include, but are not limited to: ignition resistant additives, stabilizers, colorants, antioxidants, antistats, flow enhancers, silicon oils, such as polydimethylsiloxanes, mold releases, such as metal stearates (for example, calcium stearate, magnesium stearate), nucleating agents, including clarifying agents, etc. Preferred examples of additives are ignition resistance additives, such as, but not limited to halogenated hydrocarbons, halogenated carbonate oligomers, halogenated diglycidyl ethers, organophosphorous compounds, fluorinated olefins, antimony oxide and metal salts of aromatic sulfur, or a mixture thereof may be used. Further, compounds which stabilize polymer compositions against degradation caused by, but not limited to heat, light, and oxygen, or a mixture thereof may be used.

If used, such additives may be present in an amount from at least about 0.01 parts, preferably at least about 0.1 parts, more preferably at least about 1 parts, more preferably at least about 2 parts and most preferably at least about 5 parts by weight based on the total weight of the propylene polymer composition. Generally, the additive is present in an amount less than or equal to about 25 parts, preferably less than or equal to about 20 parts, more preferably less than or equal to about 15 parts, more preferably less than or equal to about 12 parts, and most preferably less than or equal to about 10 parts by weight based on the total weight of propylene polymer composition.

Preparation of the propylene polymer compositions of this invention can be accomplished by any suitable mixing means known in the art, including dry blending the individual components and subsequently melt mixing, either directly in the extruder used to make the finished article (for example, the automotive part), or pre-mixing in a separate extruder (for example, a Banbury mixer). Dry blends of the propylene polymer compositions can also be directly injection molded without pre-melt mixing. Alternatively, the propylene polymer and the substantially linear ethylene polymer or linear ethylene polymer may be prepared in the same reactor.

The propylene polymer compositions of the present invention are thermoplastic. When softened or melted by the application of heat, the polymer blend compositions of this invention can be formed or molded using conventional techniques such as compression molding, injection molding, gas assisted injection molding, calendering, vacuum forming, thermoforming, extrusion and/or blow molding, alone or in combination. The propylene polymer compositions of the present invention are preferably injection molded.

In certain fabricated automotive articles, especially injection molded parts, it is desirable to provide a CLTE (as measured according to DIN 53752 A) of less than about 85 cm/cm×10⁻⁶/° C. between the temperature range of about −30 to 30° C. and less than about 120 cm/cm×10^{31 6}/° C. between the temperature range of about 20 to about 80° C., a compression set (as measured according to ISO 815) of less than about 100 percent, more preferably less than about 75 percent and most preferably less than about 55 percent and a scratch resistance (as measured according to GME 60280) of less than about 1 DL, more preferably less than about 0.9 DL and most preferably less than about 0.8 DL.

To illustrate the practice of this invention, examples of the preferred embodiments are set forth below. However, these examples do not in any manner restrict the scope of this invention.

### EXAMPLES

The compositions of Comparative Examples A and B and Examples 1 to 17 were compounded on a co-rotating twin screw Collin ZK-50/R DGL (L/D-12) extruder. All components were dry blended prior to feeding through a K-tron loss-and-weight feeder.

Extruder output was 10 kilograms per hour (kg/h.). The following were the compounding conditions on the ZK-50/R extruder: Barrel temperature profile: 200° C., 210° C., 220° C., 230° C.; Die temperature: 230° C.; Melt temperature: 220° C.; Screw speed: 100 revolutions per minute (rpm). The extrudate was cooled in the form of strands and comminuted as pellets using a Sheer SGS 50-E pelletizer. The pellets were used to prepare test specimens on a 100 ton Demag injection molding machine, having the following molding conditions: Barrel temperature profile: 200° C., 205° C., 230° C., 220° C., and 220° C.; Melt temperature: 225° C.; and Cycle time: 85 seconds.

The formulation content of Comparative Examples A and B and Examples 1 to 17 are given in Table 1 below in parts by weight of the total composition. In Table 1:

“PP-1” is a polypropylene available as INSPIRE™ C704-07 available from The Dow Chemical Company having a density of 0.9 g/cm³, a melt flow rate of 7 g/10 min. at 230° C. and an applied load of 2.16 kg;

“PP-2” is a polypropylene available as INSPIRE C705-44NAHP available from The Dow Chemical Company having a density of 0.9 g/cm³, a melt flow rate of 44 g/10 min. at 230° C. and an applied load of 2.16 kg;

“PP-3” is a polypropylene available as ADSTIF™ V2400G available from Montell having a density of 0.9 g/cm³, a melt flow rate of 20 g/10 min. at 230° C. and an applied load of 2.16 kg;

“SLEP” is a substantially linear ethylene/octene copolymer available as AFFINITY™ EG 8150 from The Dow Chemical Company having a density of 0.868 g/cm³, a melt flow rate of 0.5 g/10 min. determined at 190° C. and an applied load of 2.16 kg;

“SRI-1” is an ethylene:styrene (60:40) substantially random interpolymer available from the Dow Chemical Company having a density of 0.945 and a MI of 0.75 (determined at 190° C. and an applied load of 2.16 kg);

“SRI-2” is an ethylene:styrene (70:30) substantially random interpolymer available from the Dow Chemical Company having a density of 0.9064 and a MI of 0.6 (determined at 190° C. and an applied load of 2.16 kg);

“SRI-3” is an ethylene:styrene (30:70) substantially random interpolymer available from the Dow Chemical Company having a density of 1.017 and a MI of 1 (determined at 190° C. and an applied load of 2.16 kg);

“SRI-4” is an ethylene:propylene:styrene (70:16:14) substantially random interpolymer available from the Dow Chemical Company having a density of 0.937 and a MI of 1 (determined at 190° C. and an applied load of 2.16 kg);

“HDPE” is a high density polyethylene available as HDPE 96003E from the Dow Chemical Company having a density of 0.960 g/cm³ and a melt flow rate of 1 g/10 min. determined at 190° C. and an applied load of 2.16 kg;

“TALC” is a commercially available mineral talc available as MISTRON G7C from Luzenac having a median particle size of 2-3 μm and a maximum particle size of 8 μm;

“Erucamide” is an unsaturated fatty amide with the formula C₂₁H₄₁CONH₂ available as KEMAMIDE™ from Witco;

“CHIMASSORB™ 119” is a UV stabilizer available from Ciba Geigy;

“IRGANOX B 215” is an antioxidant available from Ciba Geigy is a 1:2 mixture of 3,5-bis(1,1-dimethylethyl)-4-hydroxy-2,2-bis[3-[3,5-bis(1,1-dimethylethyl)-4-hydroxyphenyl] oxo-propoxy]methyl-1,3-propanediyl ester with tris(2,4-di-tert-butylphenyl phosphite;

“Plasblack 4045” is a black concentrate available from Cabot; and

“Color” is produced by a combination of pigments to give the color Joker Blue.

One or more of the following tests are run on Comparative Examples A and B and Examples 1 to 17 and the results of these tests are shown in Table 2:

“Density” is measured according to ISO 1183 method A;

“MFR” melt flow rate is determined according to ISO 1133 on a Zwick 4106 plastometer at 230° C. and an applied load of 2.16 kg;

“Flexural Modulus” is determined in accordance with ISO 178. Testing is performed using an Instron mechanical tester at a rate of 2 mm/min.;

“Tensile Properties” are done in accordance with ISO 527. Testing is performed using an Instron mechanical tester;

“Notched Izod” is determined according to ISO 180/A1 at 23° C., 0° C., −30° C. and/or −40° C. Specimens are cut from rectangular HDT bars and measured 4 mm in thickness. The specimens are notched with a notcher to give a 250 micrometer (μ) radius notch. A Zwick Izod impact testing unit is used;

“Dart” instrumented impact is determined according to ISO 6603 using a J&B instrumented impact tester with a 23.246 kg weight. Test results are determined at 23° C., 0° C., −10° C., −30° C. and/or −40° C. A cold chamber is used to cool the 0° C., −10° C., −30° C. and −40° C. samples prior to testing;

“Heat Deflection Temperature” is determined at 0.45 MPa and/or 1.82 MPa according to ISO 75A using a Ceast heat deflection temperature apparatus;

“Vicat” softening temperature is determined on a Ceast HDT 300 Vicat machine in accordance with ISO 306 under A50, B50 and A120 conditions;

“Ash” is determined by thermal gravimetric analysis using DuPont DSC apparatus;

“Hardness Shore D” hardness is measured according to ISO 868;

“Scratch Resistance” is determined according to standard GME 60280 from GM where 1 mm styles are applied at 5 mm and 1200 mm/min. to get cross hatch of scratches, delta L (DL) is measured before and after scratching on a Data Color International DC3890 spectrophotometer.

“Mar Resistance” is determined on a Datacolor International DC3890 spectofotometer with an Erichsen engraver according to GME standard measuring gloss 85 difference;

“Gloss 60” is 60 degree gloss determined on a textured plaque according to ISO 2813 on a Dr. Lange reflectometer;

“CLTE” coefficient of linear thermal expansion is determined on a 50×4×5 mm sample using a Netzsch Dilatometer 402 ST/1/140/6 apparatus at 2° K/min. according to DIN 53752 A, results are reported as centimeter per centimeter times 10⁻⁶/° C. (cm/cm×10⁻⁶/° C.) and

“Compression Set” is determined according to ISO 815 on stacks of 25 mm disks after 22 hours of compression at 23° C.

Example 18 is an injection molded automotive airbag cover molded from the propylene composition of Example 11. The airbag cover measures 17×19×4 centimeters (cm) having a thickness of 3 mm and a weight of 335 grams. It is molded on a 250 ton Krauss Maffei injection molding machine. The melt temperature is 220° C., the injection pressure is 50 MPa and the cycle time is 45 seconds. The airbag cover has a scratch and mar resistance of DL=0.2.

Example 19 is an injection molded doorhandle overmolding, molded from the propylene composition of Example 12. The doorhandle overmolding measures 30×8×4 cm and weighs 160 grams. It is molded on a 250 ton Krauss Maffei injection molding machine. The melt temperature is 230° C., the injection pressure is 60 MPa and the cycle time is 75 seconds. The arm rest overmolding has a scratch and mar resistance of DL=0.3.

TABLE 1

| | COMPARATIVE | | | | | | | | | | | | | | | | | | |
|---|---|---|---|---|---|---|---|---|---|---|---|---|---|---|---|---|---|---|---|
| | EXAMPLE | | EXAMPLE | | | | | | | | | | | | | | | | |
| COMPOSITION | A | B | 1 | 2 | 3 | 4 | 5 | 6 | 7 | 8 | 9 | 10 | 11 | 12 | 13 | 14 | 15 | 16 | 17 |
| PP-1 | 50 | 52 | 53 | | | | | | | | | | | | | | | | |
| PP-2 | 18 | 18 | 17 | 64 | | 40 | 60 | 40 | 60 | 40 | 60 | 20 | 30 | 20 | 30 | 20 | 30 | 20 | 20 |
| PP-3 | | | | | 57 | | | | | | | | | | | | | | |
| SLEP | 5 | 5 | | | | | | | | | | | | | | | | | |
| SRI-1 | | | 5 | 11 | 18 | | | | | | | | | | | | | | |
| SRI-2 | | | | | | 57 | 37 | 37 | 27 | | | 77 | 67 | | | 57 | 47 | 57 | 20 |
| SRI-3 | | | | | | | | 20 | 10 | | | | | | | 20 | 20 | | |
| SRI-4 | | | | | | | | | | 57 | 37 | | | 77 | 67 | | | 20 | 57 |
| HDPE | 5 | 5 | 5 | 3 | 5 | | | | | | | | | | | | | | |
| Talc | 15 | 15 | 15 | 17 | 15 | | | | | | | | | | | | | | |
| Erucamide | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| CHIMASSORB 119 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| IRGANOX B215 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| Plasblack 4045 | 6 | | | | | 2 | 2 | 2 | 2 | 2 | 2 | 2 | 2 | 2 | 2 | 2 | 2 | 2 | 2 |
| Color | | 4 | 4 | 4 | 4 | | | | | | | | | | | | | | |

TABLE 2

| | COMPARATIVE | | | | | | | | | |
|---|---|---|---|---|---|---|---|---|---|---|
| | EXAMPLE | | EXAMPLE | | | | | | | |
| | A | B | 1 | 2 | 3 | 4 | 5 | 6 | 7 | 8 |
| PROPERTIES | | | | | | | | | | |
| Density, g/ml | 1.02 | 1.02 | 1.02 | 1.02 | 1.02 | 0.9235 | 0.9165 | 0.9368 | 0.9223 | 0.9076 |
| MFR @ 230° C./2.16 kg, | 9.9 | 9.6 | 8.1 | 23.4 | 10 | 9.6 | 17 | 12.1 | 17.9 | 7.7 |
| g/10 min. | | | | | | | | | | |
| Flexural Modulus, MPa | 1900 | 1820 | 2089 | 2218 | 2458 | 506 | 866 | 209 | 791 | 461 |
| Tensile Properties | | | | | | | | | | |
| Strength at Yield, MPa | | | | | | 12.3 | 16.3 | 11.9 | 16.3 | 11.2 |
| Strength at Break, MPa | 22 | 20 | 22.3 | 20.8 | 26.7 | 16 | 13.3 | 22.2 | 14 | |
| Elongation at Yield, % | 4.7 | 4.7 | 21 | 12 | 19 | 22.1 | 9.6 | 21 | 8.6 | 22.8 |
| Elongation at Break, % | | | | | | 429.5 | 382.9 | 414.7 | 236.3 | |
| Modulus, MPa | 2000 | 1900 | 1974 | 2030 | 2310 | 529 | 826 | 572 | 830 | 466 |
| Notch Izod, kJ/m² | | | | | | | | | | |
| 23° C. | 43.6 | 30 | 26.1 | 11.8 | 7.8 | | | | | |
| 0° C. | 10 | 11 | 6.9 | 5.5 | 4.5 | | | | | |
| −30° C. | | | | | | 59.8 | 12 | 19.5 | 10.2 | nb |
| −40° C. | | | | | | 11.4 | 10.3 | 15.1 | 8.6 | nb |
| Dart Impact, J | | | | | | | | | | |
| 23° C. | 55 | 59 | 49.5 | 41 | 33 | | | | | |
| 0° C. | 37 | 56 | 61 | 41 | 19 | | | | | |
| −10° C. | 28 | 56 | 38 | 26 | 8 | | | | | |
| −30° C. | | | | | | 49.9 | 23.81 | 48.52 | 19.26 | 47.17 |
| −40° C. | | | | | | 49.07 | 6.57 | 33.03 | 17.14 | 50.18 |

| | EXAMPLE | | | | | | | | |
|---|---|---|---|---|---|---|---|---|---|
| | 9 | 10 | 11 | 12 | 13 | 14 | 15 | 16 | 17 |
| PROPERTIES | | | | | | | | | |
| Density, g/ml | 0.9062 | 0.9319 | 0.9277 | 0.9103 | 0.9097 | 0.9457 | 0.9413 | 0.9243 | 0.9147 |
| MFR @ 230° C./2.16 kg, | 16.6 | 3.5 | 5.1 | 3.7 | 5.1 | 4.1 | 5.6 | 3.7 | 3.8 |
| g/10 min. | | | | | | | | | |
| Flexural Modulus, MPa | 776 | 170 | 340 | 184 | 315 | 256 | 332 | 164 | 165 |
| Tensile Properties | | | | | | | | | |
| Strength at Yield, MPa | 15.6 | 8 | 9.4 | nb | 9.1 | 30.2 | 9.4 | 25.5 | 6.6 |
| Strength at Break, MPa | | 30 | 28 | | | 11.1 | 12.4 | 10.2 | |
| Elongation at Yield, % | 11.9 | | | | 30.4 | 405 | 38 | 442 | 54.2 |
| Elongation at Break, % | | 440 | >440 | >500 | >500 | 292 | 381 | 305 | |
| Modulus, MPa | 769 | 121 | 202 | 87 | 164 | 124 | 354 | 69 | 64 |
| Notch Izod, kJ/m² | | | | | | | | | |
| 23° C. | | | | | | | | | |
| 0° C. | | | | | | | | | |
| −30° C. | 22.3 | | | | | | | | |
| −40° C. | 14.3 | | | | | | | | |
| Dart Impact, J | | | | | | | | | |
| 23° C. | | | | | | | | | |
| 0° C. | | | | | | | | | |
| −10° C. | | | | | | | | | |
| −30° C. | 48.1 | | | | | | | | |
| −40° C. | 34.63 | | | | | | | | |

| | COMPARATIVE | | | | | | | | | |
|---|---|---|---|---|---|---|---|---|---|---|
| | EXAMPLE | | EXAMPLE | | | | | | | |
| | A | B | 1 | 2 | 3 | 4 | 5 | 6 | 7 | 8 |
| PROPERTIES | | | | | | | | | | |
| Dart Deflection, mm | | | | | | | | | | |
| 23° C. Deflection, mm | 25 | 26.4 | 21.5 | 19 | 16 | | | | | |
| 0° C. Deflection, mm | 17 | 26 | 22 | 16.9 | 10 | | | | | |
| −10° C. Deflection, mm | 13 | 23 | 15 | 12 | 6 | | | | | |
| −30° C. Deflection, mm | | | | | | 19.4 | 10.6 | 16.7 | 9.2 | 21.8 |
| −40° C. Deflection, mm | | | | | | 17.2 | 4.7 | 12.01 | 8.6 | 22.2 |
| Heat Deflection Temperature, ° C. | | | | | | | | | | |
| 0.45 Mpa | | | | | | 61.7 | 64.9 | 62.1 | 74.5 | 61.5 |
| 1.82 MPa | 60 | 58 | 56.3 | 56.4 | 56.7 | 49.2 | 50.4 | 53 | 49.8 | 46.4 |
| Vicat | | | | | | | | | | |
| A50 | | | | | | 71.9 | 113.8 | 73.7 | 114.1 | 69.5 |
| B50 | | | | | | | 48.6 | | 51.6 | |
| A120 | | | | | | 75.1 | 116.6 | 74.6 | 117.9 | 71.4 |
| Ash, percent | 16 | 17 | 14.7 | 18.7 | 16.3 | 0 | 0 | 0 | 0 | 0 |
| Hardness | | | | | | 42 | 47 | 45 | 48 | 41 |
| Scratch Resistance, DL | 0.7 | 1 | | | 0.6 | | | | | |
| Mar Resistance, | 0.7 | 1 | | | 0.3 | | | | | |
| gloss 85 difference | | | | | | | | | | |
| Gloss | 1 | 1 | 1 | 1 | 1 | 2.5 | 3 | 2.9 | 2.8 | 3.2 |
| CLTE, cm/cm × 10⁻⁶/° C. | | | | | | | | | | |
| −30 to 30° C. | 70 | 70 | | | | 68 | 80 | 73 | 82 | 69 |
| 20 to 50° C. | | | | | | | | | | |
| 20 to 80° C. | 120 | 120 | | | | 69 | 106 | 79 | 113 | 78 |
| Compression Set, percent | | | | | | | | | | |

| | EXAMPLE | | | | | | | | |
|---|---|---|---|---|---|---|---|---|---|
| | 9 | 10 | 11 | 12 | 13 | 14 | 15 | 16 | 17 |
| PROPERTIES | | | | | | | | | |
| Dart Deflection, mm | | | | | | | | | |
| 23° C. Deflection, mm | | | | | | | | | |
| 0° C. Deflection, mm | | | | | | | | | |
| −10° C. Deflection, mm | | | | | | | | | |
| −30° C. Deflection, mm | 18.6 | | | | | | | | |
| −40° C. Deflection, mm | 13.7 | | | | | | | | |
| Heat Deflection Temperature, ° C. | | | | | | | | | |
| 0.45 Mpa | 74.9 | | | | | | | | |
| 1.82 MPa | 52.6 | | | | | | | | |
| Vicat | | | | | | | | | |
| A50 | 107.6 | | | | | | | | |
| B50 | 50.2 | | | | | | | | |
| A120 | 112.5 | | | | | | | | |
| Ash, percent | 0 | 0 | 0 | 0 | 0 | 0 | 0 | 0 | 0 |
| Hardness | 46 | 34 | 41 | 30 | 40 | 37 | 44 | 35 | 35 |
| Scratch Resistance, DL | | 0.2 | | 0.0 | −0.1 | | 0.0 | | |
| Mar Resistance, | | | | | | | | | |
| gloss 85 difference | | | | | | | | | |
| Gloss | 2.8 | 2.3 | 2.7 | 3 | 2.9 | 2.5 | 2.7 | 3.1 | 3.1 |
| CLTE, cm/cm × 10⁻⁶/° C. | | | | | | | | | |
| −30 to 30° C. | 81 | 71 | 68 | 66 | 59 | 69 | 71 | 70 | 65 |
| 20 to 50 ° C. | | 68 | 75 | 69 | 66 | 61 | 70 | 73 | 66 |
| 20 to 80° C. | 103 | | 64 | 49 | 53 | 47 | 62 | 53 | 50 |
| Compression Set, percent | | 32 | 41 | | 53 | | 54 | | |

nb = no break

What is claimed is:

1. A fabricated automotive article comprising a propylene polymer composition comprising:
(a) one or more isotatic propylene polymer and
(b) one or more substantially random interpolymer prepared by polymerizing ethylene and/or one or more α-olefin monomers with one or more vinyl or vinylidene aromatic monomers and/or one or more hindered aliphatic or cycloaliphatic vinylidene monomers, and optionally with other polymerizable ethylenically unsaturated monomer(s).

2. The propylene polymer composition of claim 1 wherein
(a) the isotatic propylene polymer is present in an amount from about 20 to about 95 parts by weight and
(b) the substantially random interpolymer is present in an amount from about 80 to 5 weight percent,
wherein parts by weight are based on the total weight of the propylene polymer composition.

3. The propylene polymer composition of claim 1 is a propylene homopolymer or copolymer having a degree of crystallinity equal to or greater than about 62 percent.

4. The substantially random interpolymer of claim 1 is an ethylene/styrene, ethylene/propylene/styrene, ethylene/styrene/norbomene, or ethylene/propylene/styrene/norbornene interpolymer.

5. The substantially random interpolymer of claim 1 is an ethylene/styrene interpolymer.

6. The propylene polymer composition of claim 1 further comprising (c) a filler in an amount from about 1 part by weight to about 50 parts by weight based on the total weight of the propylene polymer composition.

7. The filler of claim 6 is talc.

8. The propylene polymer composition of claim 1 further comprising (d) an additional polymer which is a polymer other than components (a) and (b) in an amount from about 1 part by weight to about 40 parts by weight based on the total weight of the propylene polymer composition.

9. The additional polymer of claim 8 is high density polyethylene.

10. The propylene polymer composition of claim 1 further comprising (e) a slip agent in an amount from about 0.1 to about 0.5 parts based on the total weight of the propylene polymer composition.

11. The slip agent of claim 10 is erucamide.

12. A process of extruding or molding a propylene polymer composition comprising:
(a) an isotatic propylene polymer and
(b) at least one substantially random interpolymer prepared by polymerizing ethylene and/or one or more α-olefin monomers with one or more vinyl or vinylidene aromatic monomers and/or one or more hindered aliphatic or cycloaliphatic vinylidene monomers, and optionally with other polymerizable ethylenically unsaturated monomer(s)
into a fabricated automotive article.

13. The fabricated automotive article of claim 1 is a bumper fascia, spoiler, pillar, door trim, instrument panel, airbag cover, console, mat, interior skin, weather stripping, window seal, shift lever knob, or soft tough over-moldings for an arm rest.

14. The fabricated automotive article of claim 12 is a bumper fascia, spoiler, pillar, door trim, instrument panel, airbag cover, console, mat, interior skin, weather stripping, window seal, shift lever knob, or soft tough over-moldings for an arm rest.

15. The fabricated automotive article of claim 1 having a coefficient of linear expansion of less than about 85 cm/cm×10⁻⁶/° C. between the temperature range of about −30 to 30° C. and less than about 120 cm/cm×10⁻⁶/° C. between the temperature range of about 20 to about 80° C. and a compression set less than 55 percent.

16. The fabricated automotive article of claim 12 having a coefficient of linear expansion of less than about 85 cm/cm×10⁻⁶/° C. between the temperature range of about −30 to 30° C. and less than about 120 cm/cm×10⁻⁶/° C. between the temperature range of about 20 to about 80° C. and a compression set less than 55 percent.
